(19) United States
(12) Patent Application Publication
(10) Pub. No.: US 2025/0282961 A1
(43) Pub. Date: Sep. 11, 2025

(54) 3D-printed products

(71) Applicant: LANXESS Deutschland GmbH, Cologne (DE)

(72) Inventors: Marvin Kischkewitz, Düsseldorf (DE); Hans-Ulrich Borst, Elsdorf (DE); Lars May, Langenfeld (DE); Joerg-Dietrich Jentsch, Leverkusen (DE)

(73) Assignee: LANXESS Deutschland GmbH, Cologne (DE)

(21) Appl. No.: 19/041,114

(22) Filed: Jan. 30, 2025

(30) Foreign Application Priority Data
Mar. 6, 2024 (EP) 24161685.3

(51) Int. Cl. C09D 7/41; B29C 64/124; B29K 33/04; B29K 75/00; B29K 105/00; B33Y 70/00; C08K 5/3445; C09B 23/06; C09B 67/20; C09D 175/14

(52) U.S. Cl. CPC C09D 7/41; B29C 64/124; B33Y 70/00; C09B 23/06; C09B 67/0063; C09D 175/14; B29K 2033/04; B29K 2075/00; B29K 2105/0032; B29K 2995/002; C08K 5/3445

(57) ABSTRACT

The present invention relates to urethane-acrylate-resin-based 3D-printed products having a colour distance ΔE<20 from the L*a*b* coordinates for a colour number beginning with “2” of the RAL colour chart, comprising at least one orange methine dye dissolved therein, to the use of orange methine dyes for producing 3D-printed products having a colour distance ΔE<20 from the L*a*b* coordinates for a colour number of the RAL colour chart beginning with “2” by photopolymerization-based 3D printing, and to a method for increasing the lightfastness and colouristic properties of photopolymerizable urethane-acrylate-resin-based compositions and 3D-printed products to be produced therefrom having a colour distance ΔE<20 from the L*a*b* coordinates for a colour number beginning with “2” of the RAL colour chart by means of at least one orange methine dye dissolved therein.

The present invention relates to urethane-acrylate-resin-based 3D-printed products having a colour distance ΔE<20 from the L*a*b* coordinates for a colour number beginning with “2” of the RAL colour chart, comprising at least one orange methine dye dissolved therein, to the use of orange methine dyes for producing 3D-printed products having a colour distance ΔE<20 from the L*a*b* coordinates for a colour number of the RAL colour chart beginning with “2” by photopolymerization-based 3D printing, and to a method for increasing the lightfastness and colouristic properties of photopolymerizable urethane-acrylate-resin-based compositions and 3D-printed products to be produced therefrom having a colour distance ΔE<20 from the L*a*b* coordinates for a colour number beginning with “2” of the RAL colour chart by means of at least one orange methine dye dissolved therein.

### BACKGROUND OF THE INVENTION

Colour masterbatches contain colorants in dispersed or dissolved form. The colour or hue of a plastic product serves inter alia as a distinguishing feature for companies or for a particular product, as a protective component, as a safety feature or as a functional additive. Amorphous plastics such as polystyrene, polycarbonate, polymethyl methacrylate, etc., the transparency of which is to be preserved, necessitate the use of polymer-soluble dyes. In contrast to a pigment, a colorant provided for 3D printing by photopolymerization is preferably soluble in the plastic resin to be processed and not present in colloidal form.

3D printing is a method of additive manufacturing. This refers to a process in which a component is built up layer-by-layer based on digital 3D design data through the deposition of a material. “3D printing” is therefore used for the purposes of the present invention as a synonym for additive manufacturing. Additive manufacturing does however describe better that this is a production process significantly different from conventional, ablative manufacturing methods. Instead of milling a workpiece out of a solid block, for example, additive manufacturing builds components layer-by-layer from materials that are available for example in fine powder form. A variety of metals, plastics and composites are available as materials.

3D printing has meanwhile become established as a method of manufacturing in numerous sectors and industries. In the construction of demonstration and functional prototypes, small and medium-sized production runs, and also increasingly in mass production, this process is impressing with advantages that are not achievable with other, conventional methods. For instance, product development and market launch can be significantly accelerated and product individualizations or functional integration can be achieved in a shorter time, and often at lower cost. For major original equipment manufacturers (OEMs) from a wide range of industries, additive manufacturing by 3D printing thus offers opportunities for market differentiation in respect of new customer benefits, potential for cost reductions, and sustainability goals. In 3D printing, 3D-printed products are printed by selectively bringing a material suitable for the corresponding printing technology into the desired shape layer-by-layer in an automated process. An original equipment manufacturer or OEM is a manufacturer of components or products that does not put said items on the retail market itself; in the automotive industry the term “OEM” is used synonymously with a vehicle manufacturer.

There are various 3D printing processes for plastics. These include processes in which the plastic is generated by curing only during printing. One embodiment is photopolymerization-based 3D printing in which a photo-curing resin liquid is applied layer-by-layer and, through the use of light, subjected to a photo-curing process/polymerization or a light-induced curing. The selective layer-by-layer curing of the liquid resin is effected by a spatially limited, precisely defined, computer-controlled exposure of the resin to light within a spectral range suitable for the initiation process of the photopolymerization. UV light in particular, visible light or infrared light are suitable. The photopolymerization-based 3D printing process according to the invention is preferably stereolithography (SLA) or digital light processing (DLP). In both 3D printing variants, the setup for the corresponding devices consists of a light source with which exposure to light from above or below is possible, so-called “top-down” or “bottom-up” printing, a resin reservoir and a platform on which the layer-by-layer curing of the plastic resin to be used for the 3D printing takes place. In SLA 3D printing, the surface to be cured is exposed to light point-by-point by scanning with a laser beam; in the DLP process, the exposure takes place over the entire surface to be exposed, especially with an LCD (liquid crystal display) panel. During a typical printing process, the printing platform is immersed in the resin in the resin reservoir while the exposure program runs and creates a layer. Repeated layer creation results ultimately in the 3D-printed product. In the SLA process, a stereolithography printer creates the 3D-printed product with a laser. A plastic solution that cures under UV light is applied for this. Corresponding 3D printers are referred to as SLA 3D printers or DLP 3D printers. A comparison of the two technologies and also suppliers of corresponding 3D printers can be found in the review article: 3Dnatives, Regina P. 8 Apr. 2021 at https://www.3dnatives.com/de/sla-vs-dlp-3d-druck-080420211/US 2004/204513 A1 provides highly sensitive compositions polymerizable with two photons that are capable of photopolymerization by two-photon absorption and can at the same time dye a polymer to a desired colour during the polymerization of said polymer. Such compositions polymerizable by two-photon absorption comprise at least (A) a polymerizable compound, (B) a two-photon absorption compound, (C) a polymerization initiator and (D) a dye.

US 2011/0070976 A1 describes a golf ball consisting of a core, at least one layer enveloping the core and a fluorescent pigment colour layer to be applied to the surface of the outermost layer of the shell. The outermost layer may consist of a thermoplastic polyurethane material (Pandex® T8290 or Pandex® T8283). For the colour layer to be applied to the outermost layer, the orange fluorescent dye Solvent Orange 60 (Sumiplast® Orange HRP) is used in the examples. The ball has excellent spin performance and durability, an appearance that is characterized by excellent visibility, style and luxuriousness and also excellent weather resistance. US 2019/0201171 A1 discloses coloured, curable compositions for use in an additive manufacturing process in which the composition comprises: a curable resin composition comprising radiation-curable components, a photoinitiator and a dye composition comprising a dye D1 and a dye D2, where dye D1 has a light absorption maximum within a 400 to 530 nm wavelength range and dye D2 has a light absorption maximum within a 540 to 650 nm wavelength range. As an example, two anthraquinone dyes are used: C.I. Solvent Red 111, CAS No. 82-38-2 (dye 1) and C.I. Solvent Violet 13, CAS No. 81-48-1 (dye 2). It also describes an S30 3D printer (Rapid Shape GmbH, Heimsheim, Germany) that employs an LED light with a wavelength of 405 nm at an intensity of 50 mW/cm² for 11 sec per layer to be applied.

In addition to advantageous colour properties during and immediately after the process for producing a 3D-printed product by photopolymerization, the properties in use of such 3D-printed products must also be considered. The colorants used in the prior art mentioned above have proven unfavourable because of the changes in colour that occur in the 3D manufacturing process as a consequence of the exposure to light needed for the photopolymerization. Sensitivity to light/lightfastness is however a quality characteristic for coloured 3D-printed products produced by photopolymerization-based 3D printing. Fading or discoloration as far as browning of a 3D-printed product produced by photopolymerization-based 3D printing should as far as possible be avoided.

Moreover, during photopolymerization, preferably photopolymerization by the SLA or DLP process, colorants intended for 3D printing should retain their advantageous performance characteristics and must not impair or even prevent the curing/polymerization of the 3D-printed product. For the purposes of the present invention, advantageous performance characteristics in the orange dyes to be defined for 3D printing according to the invention are the establishment of a desired/defined hue and the establishment of a pure, brilliant colour.

The problem addressed by the present invention is that of providing orange dyes for 3D printing by photopolymerization, in particular photopolymerization by the SLA or DLP method, that, by virtue of their solubility in the plastic to be processed, permit a defined orange hue to be established, remain lightfast during the printing process and also retain their colouristic properties.

### Method for Evaluating Lightfastness

To determine the lightfastness of dyes for photopolymerization-based 3D printing, test specimens are produced for the purposes of the present invention in the form of a cuboid of coloured resin having the dimensions length=60 mm, width=40 mm and height=2 mm and having a dye concentration of 0.02% in the resin. These test specimens are then exposed to light (xenon lamp) in the print-fresh state for 95-100 h according to DIN EN ISO 4892-2 using a Xenotest Beta+device (Atlas Material Testing Technology GmbH, Linsengericht-Altenhaßlau, Germany). Lightfastness is evaluated colorimetrically by recording transmission spectra of the light-exposed test specimens with an X-Rite Ci7800 sphere spectrophotometer (X-Rite GmbH, Planegg-Martinsried, Germany), choosing the following settings: measurement geometry=d/8°; spectral interval=10 nm; spectral range=360-750 nm. From the transmission spectra obtained, the manufacturer's software for the sphere spectrophotometer then calculates the colorimetric data with the following settings: light source/observer=D65/10°; colour space=L*a*b*C*h°. The basis for the evaluation of lightfastness is the colour distances ΔE in the L*a*b*C*h° colour space between light-exposed test specimens and the corresponding unexposed test specimens. The greater the colour distance, the greater the change in colour impression brought about by exposure to light and thus the poorer the lightfastness. AE is classified on the basis of a comparison with other orange dyes as noninventive examples for which the lightfastness in other uses, particularly in the bulk colouring of plastics, is generally evaluated as good according to the manufacturer's data.

### Method for Evaluating the Stability of Coloristic Properties

In order to establish the change in the spectral properties that determine the colouristic properties of a dye, the absorption spectra before and after light-induced curing of the investigated coloured resins are compared for the purposes of the present invention.

For this, the coloured resins produced as described in the above section “Method for evaluating lightfastness” are transferred to a quartz glass cuvette with a width of 1 cm and absorption spectra in transmission mode are recorded with the X-Rite Ci7800 instrument (X-Rite GmbH, Planegg-Martinsried, Germany) in the 360 to 750 nm wavelength range. These absorption spectra are then corrected for the absorbance of the corresponding uncoloured resin by performing the same measurement with the uncoloured resin. In analogous manner thereto, the absorption spectra in transmission mode of the coloured test specimens are recorded and corrected and the spectra in each case normalized to the path length of the cuvette/of the investigated test specimen.

Finally, the similarity of the absorption spectra before and after 3D printing is calculated from the measured data by calculating the correlation coefficient R of the normalized absorption (spectral interval 10 nm). The greater the value for R, the greater the similarity of the absorption spectra and the more stable the colouristic properties of a dye intended for photopolymerization-based 3D printing and suitable for the purposes of the present invention.

### SUMMARY OF THE INVENTION

The solution to the problem, which is provided by the present invention, is 3D-printed products having a colour distance ΔE<20 from the L*a*b* coordinates for a colour number beginning with “2” of the RAL colour chart, based on photopolymerizable compositions comprising at least one urethane acrylate resin and at least one orange methine dye having a molecular weight in the range from 50 to 1000 g/mol and having a solubility in the urethane-acrylate-resin-based composition, to be determined according to DIN EN ISO 7579:2010 DE, of ≥0.05 g/L at 23° C.

The present invention also provides for the use of at least one orange methine dye having a molecular weight in the range from 50 to 1000 g/mol for increasing the lightfastness and colouristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number beginning with “2” of the RAL colour chart and having a dye solubility in the urethane-acrylate-resin-based composition, to be determined according to DIN EN ISO 7579:2010 DE, of ≥0.05 g/L at 23° C. The increase in lightfastness and in colouristic properties in the use according to the invention is measured by recording transmission spectra before and after light-induced curing of test specimens of correspondingly coloured urethane acrylate resins using a sphere spectrophotometer and then correcting for the absorbance of the corresponding uncoloured resin and normalizing to the path length of the cuvette/of the investigated test specimen, and then finally determining from the measured data the similarity of the absorption spectra before and after 3D printing by calculating the correlation coefficient R of the normalized absorbance.

The invention further relates to a method for increasing the lightfastness and colouristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number beginning with “2” of the RAL colour chart using at least one orange methine dye having a molecular weight in the range from 50 to 1000 g/mol and a solubility in the urethane-acrylate-resin-based composition, to be determined according to DIN EN ISO 7579:2010 DE, of ≥0.05 g/L at 23° C. As with the use according to the invention, the increase in lightfastness and in colouristic properties in the method according to the invention is measured by recording transmission spectra before and after light-induced curing of test specimens of correspondingly coloured urethane acrylate resins using a sphere spectrophotometer and then correcting for the absorbance of the corresponding uncoloured resin and normalizing to the path length of the cuvette/of the investigated test specimen, and then finally determining from the measured data the similarity of the absorption spectra before and after 3D printing by calculating the correlation coefficient R of the normalized absorbance.

Finally, the invention also relates to a process for additive manufacturing of 3D-printed products having a colour distance ΔE<20 from the L*a*b* coordinates for a colour number beginning with “2” of the RAL colour chart using urethane-acrylate-resin-based compositions comprising at least one orange methine dye having a molecular weight in the range from 50 to 1000 g/mol and a solubility in the urethane-acrylate-resin-based composition, to be determined according to DIN EN ISO 7579:2010 DE, of ≥0.05 g/L at 23° C. in a photopolymerization-based SLA 3D printer or DLP 3D printer.

By way of clarification, it should be noted that the scope of the present invention encompasses all definitions and parameters mentioned hereinafter in general terms or specified in preferred ranges, in any desired combinations. This likewise relates to the combination of the stated amounts for the individual components in relation to the processes and uses claimed. The standards cited in the context of this application relate to the edition current at the filing date of the present invention. Percent values are percentages by weight unless otherwise stated.

TABLE 1
RAL colour chart for orange
In the context of the present invention, orange is considered to
mean a colour which, in the RAL colour system according to
https://de.wikipedia.org/wiki/RAL-Farbe#Orange, has a colour
number beginning with a “2” in the RAL colour chart.
In particular, at the filing date of the present invention,
the following distinctions are made between orange hues:

| | | L* | a* | b* |
|---|---|---|---|---|
| RAL 2000 | Yellow orange | 58.20 | 37.30 | 68.68 |
| RAL 2001 | Red orange | 49.41 | 39.79 | 35.29 |
| RAL 2002 | Blood orange | 47.74 | 47.87 | 33.73 |
| RAL 2003 | Pastel orange | 66.02 | 41.22 | 52.36 |
| RAL 2004 | Pure orange | 56.89 | 50.34 | 49.81 |
| RAL 2005 | Luminous orange | 72.27 | 87.78 | 82.31 |
| RAL 2007 | Luminous bright orange | 76.86 | 47.87 | 97.63 |
| RAL 2008 | Bright red orange | 60.33 | 46.91 | 60.52 |
| RAL 2009 | Traffic orange | 55.83 | 47.79 | 48.83 |
| RAL 2010 | Signal orange | 55.39 | 40.10 | 42.42 |
| RAL 2011 | Deep orange | 59.24 | 40.86 | 64.50 |
| RAL 2012 | Salmon orange | 57.75 | 40.28 | 30.66 |
| RAL 2013 | Pearl orange | 40.73 | 32.14 | 34.92 |

The table shows the apparatus-independent CIE L*a*b* colour values for the respective RAL values for orange: L* stands for luminance, a* describes the colour locus with respect to the red-green axis and b* describes the colour locus with respect to the yellow-blue axis using D65 standard light with a 10° field of view of a standard observer. The colour model is standardized in EN ISO 11664-4 “Colorimetry-Part 4: CIE 1976 L*a*b* Colour space”. For L*a*b* colour space (also: CIELAB) see: https://de.wikipedia.org/wiki/Lab-Farbraum. Each colour in the colour space is defined by a colour locus having the Cartesian coordinates {L*, a*, b*}. The a*b* coordinate plane was constructed using opponent colour theory. Green and red are at opposite ends of the a* axis from one another and the b* axis runs from blue to yellow. Complementary hues are respectively opposite one another at a 180° angle; all achromatic colours are arranged in the middle thereof (the coordinate origin a*=0, b*=0).

The L* axis describes the brightness (luminance) of the colour with values of 0 to 100. In the diagram it stands perpendicular to the a*b* plane at the origin. It may also be referred to as the neutral grey axis since all achromatic colours (grey hues) are contained between the endpoints of black (L*=0) and white (L*=100). The a* axis describes the green or red component of a colour, where negative values represent green and positive values represent red. The b* axis describes the blue or yellow component of a colour, where negative values represent blue and positive values represent yellow.

The a* values range from approximately −170 to +100 and the b* values from −100 to +150, the maximum values being achieved only at moderate brightness of certain hues. The CIELAB colour entity has its greatest extent in the region of moderate brightness, but this differs in height and size depending on the colour range.

According to the invention, hues similar to orange have a colour distance ΔE<20 from the L*a*b* coordinates for a colour number beginning with “2” of the RAL colour chart.

### Preferred Orange Methine Dyes According to the Invention

Methine dyes, also referred to as polymethine dyes, are according to https://de.wikipedia.org/wiki/Methinfarbstoffe#:˜:text=Die%20Methinfarbstoffe%20enthalten%20eine%20ungerade,kationisch%2C%20anionisch%20oder%20neutral%20sein dyes in which the chromophore system consists of conjugated double bonds (polyenes) flanked by two end groups—an electron acceptor A and an electron donor D—as per formula (I):

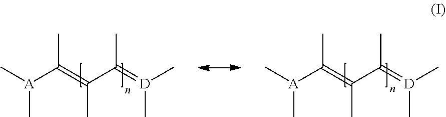

Methine dyes contain an odd number of methine groups. The end groups may be part of a heterocycle and the double bonds may be part of an aromatic system. This gives rise to different subclasses for methine dyes. Methine dyes can be characterized as polyene dyes having terminal electron-donor and -acceptor groups. In most cases, the end groups of methine dyes contain nitrogen or oxygen atoms. However, while polyene dyes, which generally occur as natural dyes such as the carotenoids, are limited to yellow to yellow-red hues, it is possible with the predominantly synthetic methine dyes to achieve almost any colour of the spectrum. Preferred orange methine dyes for the colouring of plastics and therefore, in accordance with the invention, for photopolymerization-based 3D printing are merocyanine dyes having an amino group and a carbonyl group as end groups of the polyene structural element. This type of dye may be formulated in either a neutral or zwitterionic mesomeric canonical form, as per formula (II).

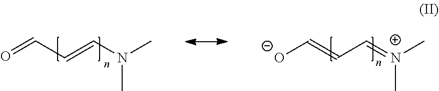

A well-known representative of the merocyanine dyes is Macrolex® Orange R, CAS No. 185766-20-5, or Solvent Orange 107.

Methine dyes relevant for the colouring of plastics that are also, according to the invention, to be used with preference for 3D printing are the styryl dyes obtained by condensation of an active methylene compound, for example malononitrile, with a benzaldehyde derivative. As a result of the integration of a benzene ring into the polyene portion, these compounds possess a styrene substructure.

### PREFERRED EMBODIMENTS OF THE INVENTION

Preferably, the urethane-acrylate-resin-based compositions employable according to the invention and 3D-printed products to be produced therefrom have a colour distance ΔE<10 from the L*a*b* coordinates for a colour number beginning with “2” of the RAL colour chart for the colour orange.

Particularly preferably, the urethane-acrylate-resin-based compositions employable according to the invention and 3D-printed products to be produced therefrom have a colour distance ΔE<5 from the L*a*b* coordinates for a colour number beginning with “2” of the RAL colour chart for the colour orange.

Preferably, the invention relates to 3D-printed products having a colour distance ΔE<20 from the L*a*b* coordinates for a colour number beginning with “2” of the RAL colour chart, based on compositions for additive manufacturing of 3D-printed products by photopolymerization-based 3D printing, comprising at least one urethane acrylate base resin and at least one orange methine dye having a molecular weight in the range from 50 to 1000 g/mol and a dye solubility in the urethane-acrylate-resin-based composition, to be determined according to DIN EN ISO 7579:2010 DE, of ≥0.05 g/L at 23° C.

Preferably, the invention relates to a method for increasing the lightfastness and colouristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number beginning with “2” of the RAL colour chart by means of additive manufacturing in 3D printing using at least one orange methine dye having a molecular weight in the range from 50 to 1000 g/mol and a solubility in the urethane-acrylate-resin-based composition, to be determined according to DIN EN ISO 7579:2010 DE, of ≥0.05 g/L at 23° C.

Preferably, the invention relates to the use of at least one orange methine dye having a molecular weight in the range from 50 to 1000 g/mol for increasing the lightfastness and colouristic properties, to be determined according to DIN EN ISO 4892-2, of photopolymerizable urethane-acrylate-resin-based compositions and 3D-printed products to be produced therefrom having a colour distance ΔE<20 from the L*a*b* coordinates for a colour number beginning with “2” of the RAL colour chart by means of additive manufacturing in 3D printing and having a dye solubility in the urethane-acrylate-resin-based composition, to be determined according to DIN EN ISO 7579:2010 DE, of ≥0.05 g/L at 23° C. Preferred methine dyes for the use according to the invention are orange merocyanine dyes having an amino group and a carbonyl group as end groups of the polyene structural element, or orange styryl dyes obtained by condensation of an active methylene compound with a benzaldehyde derivative and possessing a styrene substructure as a result of integration of a benzene ring into the polyene portion.

Preferably, the invention relates to 3D-printed products, to a use according to the invention, and to a method according to the invention for increasing the lightfastness and colouristic properties of 3D-printed products in which 0.005 to 5 parts by mass of methine dye are used per 20 to 99.995 parts by mass of urethane-acrylate-based resin, which preferably contains additives.

Particularly preferably, in addition to the at least one methine dye the urethane acrylate resin also includes 0.5-10 parts by mass of a photoinitiator that preferably absorbs in the 300 to 450 nm wavelength range.

Very particularly preferably, in addition to the at least one methine dye and the 0.5-10 parts by mass of photoinitiator the urethane acrylate resin also includes 0.001-1 parts by mass of at least one additive, preferred additives for the purposes of the present invention being at least one levelling agent, at least one stabilizer, at least one additional dye different from the methine dye, at least one filler or at least one organic pigment.

### Urethane-Acrylate-Based Resins

Photopolymerizable urethane-acrylate-based resins that are preferred according to the invention, particularly for additive manufacturing in 3D printing, are based on polyurethane acrylate [CAS No. 82116-59-4], polyether urethane acrylate or urethane acrylate resins. Reference should be made to WO 2005/028532 A1, RU 2546966 C1 or M. Alishiri et al., Materials Science and Engineering: C, vol. 42, September 2014, pp. 763-773.

Used in the context of the present invention and therefore particularly preferred is “3D Printing UV Sensitive Resin Clear” from Shenzhen Anycubic Technology Co., Ltd, China; a colourless resin for high-speed light-induced 3D printing containing 30-60% of polyurethane acrylate CAS No. 82116-59-4; 10-40% of isooctyl acrylate CAS No. 29590-42-9 and 2-5% of photoinitiator.

Photopolymerizable resins employable according to the invention preferably comprise in addition to the at least one dye normally a mixture of at least one polymerizable monomer, preferably an acrylate, and/or prepolymer, preferably a (poly) urethane acrylate, at least one photoinitiator and at least one additive. With regard to such additives, reference should in principle be made to WO 2018/038954 A1, the content of which is fully incorporated in the present description. The photoinitiators and additives to be used with preference are listed below.

### Photoinitiator

A photoinitiator employable according to the invention is normally characterized by one or more of the following features,
by one or more light absorption bands in a 300 to 450 nm wavelength range and/or a solubility in the curable composition of at least 2 g/l at 23° C.;
a solubility in the radiation-curable components of the curable resin composition and/or in the additive(s) optionally present;
an ability to form a polymerization-reaction-inducing species when exposed to light energy having a wavelength of between 300 and 450 nm, for example by free radicals.

Particular preference according to the invention is given to using at least one photoinitiator from the following group: 2-hydroxy-2-methyl-1-phenylacetone, 1-hydroxycyclohexyl phenyl ketone, 2,4,6-trimethylbenzoyldiphenylphosphine oxide, phenylbis(2,4,6-trimethylbenzoyl) phosphine oxide, ethyl(2,4,6-trimethylbenzoyl)phenylphosphinate.

### Additives

A photopolymerizable resin composition employable according to the invention for 3D printing may preferably comprise at least one additive, stabilizer(s) or mixtures thereof.

In particular, the addition of stabilizer(s) to the curable composition can contribute to improving the resolution and accuracy of the SLA process, by attenuating or preventing undesirable scattering effects, and also to extending the shelf life of the curable composition. Such stabilizers commonly contain a phenol unit. Preference is given to p-methoxyphenol (MOP), hydroquinone monomethyl ether (MEHQ), 2,6-di-tert-butyl-4-methylphenol (BHT; Ionol), phenothiazine, 2,2,6,6-tetramethylpiperidine-1-oxyl radical (TEMPO) and mixtures thereof. Such stabilizer(s) are preferably used in the following amounts:
Lower amount: at least 0.001%, or at least 0.005%, or at least 0.01%, by weight;
Upper amount: not more than 0.02%, or not more than 0.05%, or not more than 0.5%, or not more than 1%, by weight;
Range: from 0.001% to 1%, or from 0.005% to 0.05%, by weight;
   where % by weight is based on the weight of the curable composition.

### Methine Dyes

Orange methine dyes employable according to the invention are characterized by the following features:
molecular weight in the range from 50 to 1000 g/mol
solubility in the curable composition of at least 0.05 g/L at 23° C.
light absorption maximum in a 400 to 560 nm wavelength range
very good lightfastness in the 3D article
colouristic properties that are highly stable in respect of the curing process
contain at least one methine unit.

Methine dyes employable with preference according to the invention include at least one structure of the formula (V) in which R¹ denotes C₁-C₄ alkyl, preferably methyl, ethyl, n-propyl, isopropyl, n-butyl, isobutyl or tert-butyl, and R² denotes C₁-C₄ alkyl, preferably cyclohexyl, methyl, ethyl, n-propyl, isopropyl, n-butyl, isobutyl or tert-butyl,

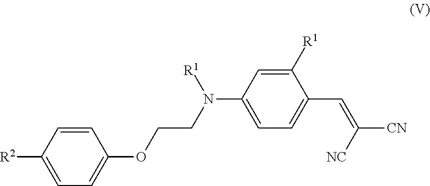

or they contain a structural element of the formula (VIII)

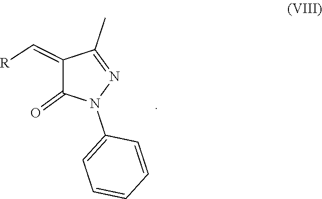

in which R denotes a radical:

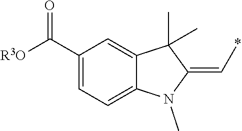

or a radical:

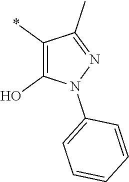 [SMILES: *c1c(C)nn(-c2ccccc2)c1O]

and R³ denotes C₁-C₄ alkyl, preferably methyl, ethyl, n-propyl, isopropyl, n-butyl, isobutyl or tert-butyl.

Methine dyes employable with particular preference according to the invention include at least one structure of the formulas (V), (VI) or (VII)

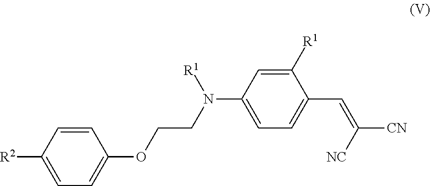

in which R¹ denotes C₁-C₄ alkyl, preferably methyl, ethyl, n-propyl, isopropyl, n-butyl, isobutyl or tert-butyl, and R² denotes C₁-C₄ alkyl, preferably cyclohexyl, methyl, ethyl, n-propyl, isopropyl, n-butyl, isobutyl or tert-butyl,

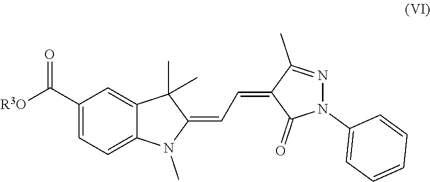

in which R³ denotes C₁-C₄ alkyl, preferably methyl, ethyl, n-propyl, isopropyl, n-butyl, isobutyl or tert-butyl,
or

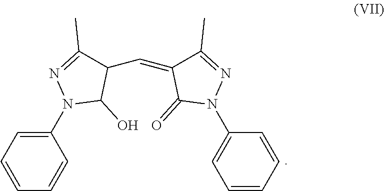 [SMILES: CC1=NN(c2ccccc2)C(=O)/C1=C\C1C(C)=NN(c2ccccc2)C1O]

A methine dye employable with very particular preference according to the invention is 1,3,3-trimethyl-2-[2-(3-methyl-5-oxo-1-phenyl-1,5-dihydropyrazol-4-ylidene)-ethylidene]-2,3-dihydroindole-5-carboxylic acid methyl ester; Solvent Orange 107, CAS No. 185766-20-5.

The method for increasing the lightfastness and colouristic properties, to be determined according to DIN EN ISO 4892-2, of photopolymerizable urethane-acrylate-resin-based compositions is preferably employed in additive manufacturing of 3D-printed products, more preferably in additive manufacturing by photopolymerization, especially preferably in additive manufacturing of 3D-printed products using a photopolymerization-based SLA 3D printer or DLP 3D printer.

Therefore, the present invention also relates to a process for additive manufacturing of 3D-printed products having a colour distance ΔE<20 from the L*a*b* coordinates for a colour number beginning with “2” of the RAL colour chart using urethane-acrylate-resin-based compositions comprising at least one orange methine dye having a molecular weight in the range from 50 to 1000 g/mol and a solubility in the urethane-acrylate-resin-based composition, to be determined according to DIN EN ISO 7579:2010 DE, of ≥0.05 g/L at 23° C. in a photopolymerization-based SLA 3D printer or DLP 3D printer. Preferably, the orange methine dye includes at least one structure of the formula (V) in which R¹ denotes C₁-C₄ alkyl, preferably methyl, ethyl, n-propyl, isopropyl, n-butyl, isobutyl or tert-butyl, and R² denotes C₁-C₄ alkyl, preferably cyclohexyl, methyl, ethyl, n-propyl, isopropyl, n-butyl, isobutyl or tert-butyl,

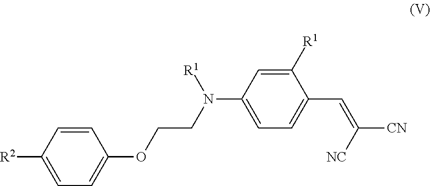

or contains a structural element of the formula (VIII)

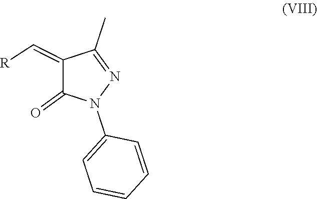

in which R denotes a radical:

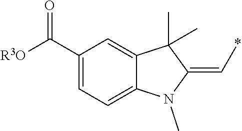

or a radical:

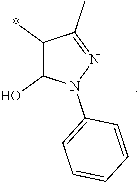 [SMILES: *C1C(C)=NN(c2ccccc2)C1O]

and R³ denotes C₁-C₄ alkyl, preferably methyl, ethyl, n-propyl, isopropyl, n-butyl, isobutyl or tert-butyl.

Particularly preferably, the methine dye to be employed in the process according to the invention has at least one structural unit of the formulas (V), (VI) or (VII)

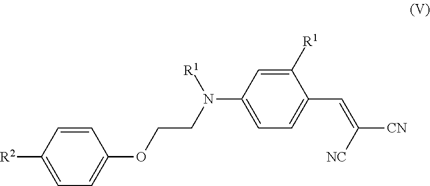

in which R¹ denotes C₁-C₄ alkyl, preferably methyl, ethyl, n-propyl, isopropyl, n-butyl, isobutyl or tert-butyl, and R² denotes C₁-C₄ alkyl, preferably cyclohexyl, methyl, ethyl, n-propyl, isopropyl, n-butyl, isobutyl or tert-butyl,

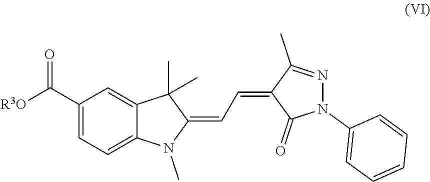

in which R³ denotes C₁-C₄ alkyl, preferably methyl, ethyl, n-propyl, isopropyl, n-butyl, isobutyl or tert-butyl,

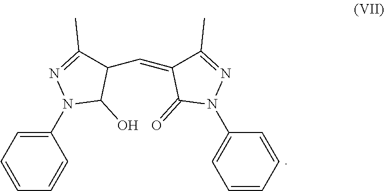 [SMILES: CC1=NN(c2ccccc2)C(=O)/C1=C\C1C(C)=NN(c2ccccc2)C1O]

Finally, the invention very particularly preferably relates to a process for additive manufacturing of 3D-printed products having a colour distance ΔE<20 from the L*a*b* coordinates for a colour number beginning with “2” of the RAL colour chart using urethane-acrylate-resin-based compositions comprising at least one orange methine dye having a molecular weight in the range from 50 to 1000 g/mol and a solubility in the urethane-acrylate-resin-based composition, to be determined according to DIN EN ISO 7579:2010 DE, of ≥0.05 g/L at 23° C. in a photopolymerization-based SLA 3D printer or DLP 3D printer, where the methine dye is:

1,3,3-trimethyl-2-[2-(3-methyl-5-oxo-1-phenyl-1,5-dihydropyrazol-4-ylidene)-ethylidene]-2,3-dihydroindole-5-carboxylic acid methyl ester; Solvent Orange 107, CAS No. 185766-20-5.

It will be understood that the specification and examples are illustrative but not limitative of the present invention and that other embodiments within the spirit and scope of the invention will suggest themselves to those skilled in the art.

### Examples

### Method for Determining the Lightfastness of Dyes in 3D Printing

To determine the lightfastness of dyes in 3D printing, test specimens made of coloured resin based on resin composition 1 (see Table 6) having a dye concentration of 0.02% by weight in the resin were produced for the purposes of the present invention. As test specimen, a cuboid having the following dimensions was produced from the coloured resin by 3D printing:

| | |
|---|---|
| Length | 60 mm |
| Width | 40 mm |
| Height | 2 mm |

The test specimens were exposed to light (xenon lamp) for 95-100 h according to DIN EN ISO 4892-2 using a Xenotest Beta+device (Atlas Material Testing Technology GmbH, Linsengericht-Altenhaßlau, Germany).

Lightfastness was evaluated colorimetrically. This was done using the X-Rite Ci7800 sphere spectrophotometer (X-Rite GmbH, Planegg-Martinsried, Germany) to record transmission spectra of the light-exposed test specimens. The following settings were chosen for this:

| Measurement geometry | d/8° | |
|---|---|---|
| Spectral interval | 10 | nm |
| Spectral range | 360-750 | nm |

From the transmission spectra, the manufacturer's software for the sphere spectrophotometer calculated the colorimetric data with the following settings:

| | |
|---|---|
| Light source/observer | D65/10° |
| Colour space | L*a*b*C*h° |

The basis for the evaluation of lightfastness was the colour distances ΔE in the L*a*b*C*h° colour space between light-exposed test specimens and the corresponding unexposed test specimens. The greater the colour distance, the greater the change in colour impression brought about by exposure to light and thus the poorer the lightfastness. AE was classified on the basis of a comparison with noninventive orange dyes (see noninventive examples) for which the lightfastness in other uses (for example the bulk colouring of plastics) is generally evaluated as good according to the manufacturer's data.

TABLE 2
Evaluation of lightfastness

| ΔE after exposure | | |
|---|---|---|
| to light in % * | Evaluation | Abbreviation |
| ≤8 | Excellent | A |
| >8-15 | Good | B |
| >15-30 | Satisfactory | C |
| >30 | Moderate to | D |
| | inadequate | |

* compared with the average ΔE of the noninventive examples (see Table 5)

### Method for Evaluating the Stability of Colouristic Properties

In order to establish the change in the spectral properties that determine the colouristic properties of a dye, the absorption spectra before and after light-induced curing of the coloured resin based on resin composition 1 were compared.

The coloured resins produced as described previously were transferred to a quartz glass cuvette with a width of 1 cm. Absorption spectra in transmission mode were then recorded with the X-Rite Ci7800 instrument (X-Rite GmbH, Planegg-Martinsried, Germany) in the 360 to 750 nm wavelength range. These were then corrected for the absorbance of the corresponding uncoloured resin by performing the same measurement with the uncoloured resin. In analogous manner thereto, the absorption spectra in transmission mode of the coloured test specimens were recorded and corrected. The spectra were in each case normalized to the path length of the cuvette or of the test specimen.

The similarity of the absorption spectra before and after 3D printing was then calculated from the measured data. This was done by calculating the correlation coefficient R of the normalized absorption (spectral interval 10 nm). The greater the value for R, the greater the similarity of the absorption spectra and thus the more stable the colouristic properties of the dye in 3D printing.

TABLE 3
Evaluation of stability/preservation of colouristic properties

| R | Evaluation | Abbreviation |
|---|---|---|
| 0.9-1 | Excellent preservation | A |
| 0.7-<0.9 | Good preservation | B |
| 0.6-<0.7 | Largely preserved | C |
| 0-<0.6 | Noticeable colour deviation, inadequate | D |

The coloured 3D prints were produced and tested according to the methods described above in three resin compositions having different properties (see Materials). In resin composition 1, dye mixtures were also investigated by way of example.

TABLE 4
Inventive example in resin composition “3D Printing UV Sensitive
Resin Clear” from Shenzhen Anycubic Technology Co., Ltd

| | | Evaluation of | | Evaluation |
|---|---|---|---|---|
| Dye | ΔE in % | exposure to light | R | of R |
| Solvent Orange 107 | 6.1 | A | 0.94 | A |

TABLE 5
Noninventive examples of orange dyes in resin composition
“3D Printing UV Sensitive Resin Clear” from
Shenzhen Anycubic Technology Co., Ltd

| | | Evaluation of | | |
|---|---|---|---|---|
| | | exposure to | | Evaluation |
| Dye | ΔE in % | light | R | of R |
| Solvent Orange 62 | 18.9 | C | 0.75 | B |
| Solvent Orange 11 | 40.8 | D | 0.78 | B |
| Solvent Orange 60 | 9.8 | B | 0.81 | B |
| Solvent Orange 113 | 9.6 | B | 0.85 | B |

### Reactants

TABLE 6
Materials used and sources of supply

| Material | Description | Source |
|---|---|---|
| 3D Printing UV Sensitive | Colourless resin for high- | Shenzhen Anycubic |
| Resin Clear | speed, light-induced 3D | Technology Co., Ltd |
| (referred to as resin | printing | |
| composition 1) | (30-60% polyurethane | |
| | acrylates CAS 82116-59-4; | |
| | 10-40% isooctyl acrylate | |
| | CAS 29590-42-9; 2-5% | |
| | photoinitiator) | |
| 12H-Phthaloperin-12-one | Perinone dye, C.I. Solvent | Lanxess Deutschland GmbH |
| | Orange 60, CAS No. 6925- | |
| | 69-5 | |
| 1,3,3-Trimethyl-2-[2-(3- | Methine dye, C.I. Solvent | Lanxess Deutschland GmbH |
| methyl-5-oxo-1-phenyl-1,5- | Orange 107, CAS No. | |
| dihydropyrazol-4-ylidene)- | 185766-20-5 | |
| ethylidene]-2,3- | | |
| dihydroindole-5-carboxylic | | |
| acid methyl ester | | |
| 2,11- | Perinone dye, C.I. Solvent | Milliken & Company |
| Diazapentacyclo[10.7.1.02, | Orange 113 | |
| 10.04, 9.016, 20]icosa- | | |
| 1(19),4(9),10,12,14,16(20),17- | | |
| heptaen-3-one | | |
| 2,4-Dihydro-4-[(2-hydroxy-5- | Azo dye/chromium complex, | abcr GmbH |
| nitrophenyl)azo]-5-methyl-2- | C.I. Solvent Orange 62, CAS | |
| phenyl-3H-pyrazol-3-one | No. 52256-37-8 | |
| chromium complex | | |
| Reaction mass of bis[2,4- | Azo dye/cobalt complex, C.I. | BASF Colors & Effects |
| dihydro-5-nitrophenyl)azo]-5- | Solvent Orange 11, CAS No. | GmbH |
| methyl-2-phenyl-3H-pyrazol- | 61725-76-6 | |
| 3-onato(2)-)] cobaltate(1-) | | |
| and sodium bis[2,4-dihydro- | | |
| 4-[(2-hydroxy-5- | | |
| nitrophenyl)azo]-5-methyl-2- | | |
| phenyl-3H-pyrazol-3- | | |
| onato(2-)] cobaltate(1-) | | |

1. A 3D-printed product having a colour distance ΔE<20 from the L*a*b* coordinates for a colour number beginning with “2” of the RAL colour chart, based on photopolymerizable compositions comprising at least one urethane acrylate resin and at least one orange methine dye having a molecular weight in the range from 50 to 1000 g/mol and having a solubility in the urethane-acrylate-resin-based composition, to be determined according to DIN EN ISO 7579:2010 DE, of ≥0.05 g/L at 23° C.

2. The 3D-printed product according to claim 1, wherein the urethane acrylate resin is based on urethane acrylate, polyurethane acrylate or polyether urethane acrylate.

3. The 3D-printed product according to claim 1, wherein the orange methine dye is a merocyanine dye having an amino group and a carbonyl group as end groups of the polyene structural element, or a styryl dye having a styrene substructure.

4. The 3D-printed product according to of claim 3, wherein the orange methine dye includes at least one structure of formulas (V), (VI) or (VII) 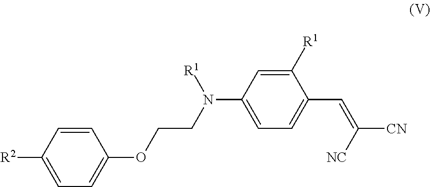
wherein R¹ denotes C₁-C₄ alkyl, and R² denotes C₁-C₄ alkyl, 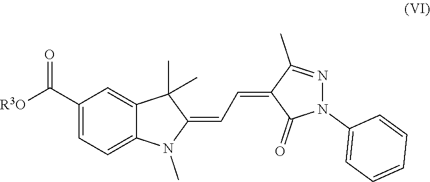
wherein R³ denotes C₁-C₄ alkyl

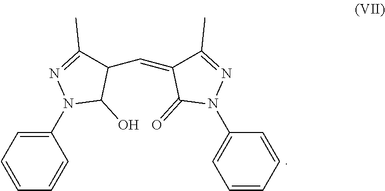 [SMILES: CC1=NN(c2ccccc2)C(=O)/C1=C\C1C(C)=NN(c2ccccc2)C1O]

5. The 3D-printed product according to of claim 4, wherein the methine dye is 1,3,3-trimethyl-2-[2-(3-methyl-5-oxo-1-phenyl-1,5-dihydropyrazol-4-ylidene)-ethylidene]-2,3-dihydroindole-5-carboxylic acid methyl ester.

6. A process for additive manufacturing of 3D-printed products having a colour distance ΔE<20 from the L*a*b* coordinates for a colour number beginning with “2” of the RAL colour chart comprising using in a urethane-acrylate-resin-based composition at least one orange methine dye having a molecular weight in the range from 50 to 1000 g/mol and a solubility in the urethane-acrylate-resin-based composition of >0.05 g/L at 23° C.

7. The process according to claim 6, wherein the at least one orange methine dye is applied in a photopolymerization-based 3D printing.

8. The process according to claim 6, wherein the urethane-acrylate-resin-based compositions is based on urethane acrylate, on polyurethane acrylate or on polyether urethane acrylate.

9. The process according to of claim 6, wherein the orange methine dye is a merocyanine dye having an amino group and a carbonyl group as end groups of the polyene structural element, or a styryl dye having a styrene substructure.

10. The process according to of claim 9, wherein the orange methine dye includes at least one structure of formulas (V), (VI) or (VII) 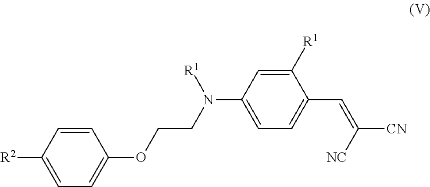
wherein R¹ denotes C₁-C₄ alkyl, and R² denotes C₁-C₄ alkyl, 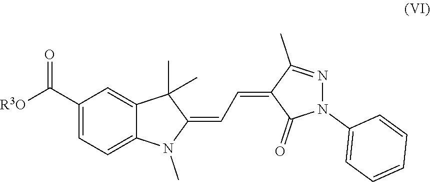
wherein R³ denotes C₁-C₄ alkyl,

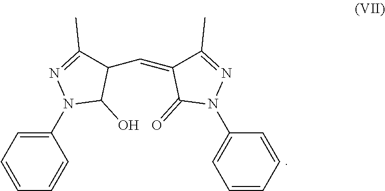 [SMILES: CC1=NN(c2ccccc2)C(=O)/C1=C\C1C(C)=NN(c2ccccc2)C1O]

11. The process according to of claim 9, wherein the methine dye is 1,3,3-trimethyl-2-[2-(3-methyl-5-oxo-1-phenyl-1,5-dihydropyrazol-4-ylidene)-ethylidene]-2,3-dihydroindole-5-carboxylic acid methyl ester.

12. A method for increasing the lightfastness and colouristic properties, to be determined according to DIN EN ISO 4892-2, of photopolymerizable urethane-acrylate-resin-based compositions and 3D-printed products to be produced therefrom, comprising using at least one orange methine dye having a molecular weight in the range from 50 to 1000 g/mol and a solubility in the urethane-acrylate-resin-based composition of ≥0.05 g/L at 23° C., with the proviso that the urethane-acrylate-resin-based compositions have a colour distance ΔE<20 from the L*a*b* coordinates for a colour number beginning with “2” of the RAL colour chart.

13. The method according to claim 12, wherein the at least one orange methine dye is used during additive manufacturing of 3D-printed products in photopolymerization-based 3D printing.

14. The method according to claim 12, wherein the urethane-acrylate-resin-based compositions are based on urethane acrylate, on polyurethane acrylate or on polyether urethane acrylate.

15. The method according to of claim 12, wherein the methine dye includes at least one structure of formulas (V), (VI) or (VII) 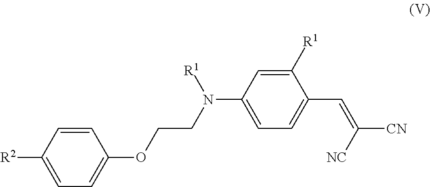
wherein R¹ denotes C₁-C₄ alkyl, and R² denotes C₁-C₄ alkyl, 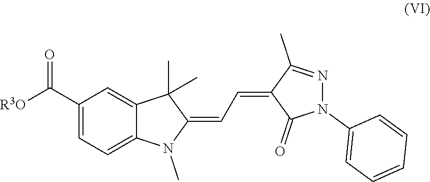
wherein R³ denotes C₁-C₄ alkyl,

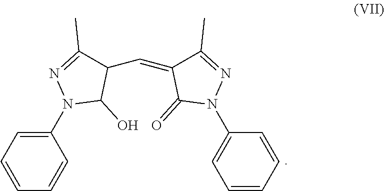 [SMILES: CC1=NN(c2ccccc2)C(=O)/C1=C\C1C(C)=NN(c2ccccc2)C1O]

16. The method according to claim 12, wherein the methine dye is 1,3,3-trimethyl-2-[2-(3-methyl-5-oxo-1-phenyl-1,5-dihydropyrazol-4-ylidene)-ethylidene]-2,3-dihydroindole-5-carboxylic acid methyl ester.
